(19) United States
(12) Patent Application Publication
(10) Pub. No.: US 2020/0216683 A1
(43) Pub. Date: Jul. 9, 2020

(54) PROTECTIVE COATING FOR CENTRAL TOWER RECEIVER IN SOLAR POWER PLANTS AND METHOD OF MAKING SAME

(71) Applicant: RIOGLASS SOLAR SCH, SL, Sevilla (ES)

(72) Inventor: Camille ZWICKER, Jerusalem (IL)

(21) Appl. No.: 16/626,246

(22) PCT Filed: Jun. 20, 2018
(86) PCT No.: PCT/IL2018/050681

§ 371 Date: Dec. 23, 2019

Related U.S. Application Data
(60) Provisional application No. 62/525,224, filed on Jun. 27, 2017.

(51) Int. Cl. C09D 5/32; F24S 20/20; F24S 70/10; F24S 70/12; F24S 70/16; F24S 70/20; F24S 70/30

(52) U.S. Cl. CPC C09D 5/32; F24S 20/20; F24S 70/10; F24S 70/30; F24S 70/16; F24S 70/20; F24S 70/12

(57) ABSTRACT

A coating for solar tubes has a porous absorbing layer that includes an absorbing black pigment material mixed with a porous binder having an open porosity, and a first protective layer having oxides applied on top of the porous absorbing layer. The first protective layer may penetrate to at least a portion of the open porosity. The first protective layer may include nanoparticles, to improve the filling of the pores. A second protective layer may be applied after the first layer, to improve the filling of the remaining gaps.

### BACKGROUND OF THE INVENTION

Solar tower technology captures and concentrates the sun radiation to provide heat and generate electricity. A solar tower system utilizes mirrors (heliostat) to focus sunlight upon a central tower receiver (CTR). The central receiver includes several panels each made of small metallic tubes made, for example, from Inconel 625, stainless steel, Hayne 230, etc. and coated with a black coating absorber. Heat Transfer Liquids (HTF) flow inside the small metallic tubes. The central tower receiver is exposed to extreme working conditions, for example, temperatures higher than 600° C., high radiation flux, thermal shocks and corrosive environment. Under these conditions, an accelerated degradation and ageing of the black coating absorber is the main cause for the decrease in the tubes' thermal performance which in turn shortens the life time of the receiver.

Accordingly, the material of choice for coating the tubes may have great influence on the performance and life span of a solar tower. Most of the coating materials in use today, which are based on black absorbing paints, suffer from instability at high temperature. Coatings made by physical vapor deposition (PVD) methods are generally very expensive and not stable at temperature higher than 600° C. in the open air. Similarly, electroplating coatings are also limited to lower temperatures.

The cheapest coating method is painting and the most commonly used paint is a paint comprising a black pigment in a silicone resin, for example, Pyromark™. The black pigment-silicone paint was formulated to resist high temperature (up to 1093° C.), has a solar absorptance of 0.96-0.975 and an emissivity of 0.85. However, under the severe conditions of a solar tower, the black pigment-silicone coating suffers from a drastic degradation, including peeling, cracks and corrosion accompanied by a significant reduction of its absorptance. The black pigment paint, (e.g., copper manganese ferrite), starts to decompose, when the temperature exceeds 800° C., the spinel decomposes into various oxides of copper, iron and manganese. The black color of the paint becomes black gray or black reddish which causes a reduction in the absorptance. Environmental conditions, such as humidity, salt level and contaminants, can also cause degradation of the paint.

There have been several attempts to increase efficiency of a central tower receiver. One approach was to increase the durability and absorbability of the paint, usually by replacing the silicone resin or looking for new black pigments. For example, a solar coating was developed that was made of a mixture of black inorganic pigments, e.g. spinels, such as manganese ferrite and copper chrome oxide, and a transparent matrix, usually an oxide (e.g., methyl siloxane, phenyl siloxane, polysilazane and the like), which serves as a binder. In yet another example, a black ceramic paint was developed using a black spinel (e.g., cobalt oxide) and a binder (e.g., silicone resin, polymer beads and the like). The spinel based paints were reported to be stable at a temperature of up to 750° C. Nevertheless, utilization of these coatings under real conditions of work of the CTR (i.e. exposure to high temperature combined with high radiation flux and thermal shock) doesn't stop or decrease the rapid degradation of the coating.

Another approach was to develop black paint with a low spinel emissivity, using for example, spinel pigments AB₂O₄ (A, B=Ni, Co, Fe, Cu) with a low emissivity. Spinel pigments, such as, NiCo₂O₄, CuCo₂O₄, and (NiFe)Co₂O₅ were found optically competitive to the Pyromark™ paint.

An additional approach was to develop a wet selective paint based on an infra-red-reflective layer (IRR), black absorber layer and anti-reflective (AR) coating. The aim of the AR coating was to decrease the reflectivity of the black coating. The AR layer was formed by the application of silica gel on top of commercial paint for solar systems, such as Solkote™ and Solarect-Z™. The AR increased the Absorptance by 1-2% but the absorbing layer was unstable and degraded at 250° C.

Therefore it is required to find a protective coating that may improve the stability of the black paint at 750 C and withstand the harsh conditions of the CTR.

### SUMMARY OF EMBODIMENTS OF THE PRESENT INVENTION

Some aspects of the invention may be directed to a coating for solar tubes. In some embodiments, the coating may include a porous absorbing layer comprising an absorbing black pigment material mixed with a porous binder having open porosity; and a first protective layer comprising oxides, the first protective layer may be applied on top of the porous absorbing layer. In some embodiments, the protective layer may penetrate to at least a portion of the open porosity.

In some embodiments, the first protective layer may have a thickness of at most 500 nm. In some embodiments, the first protective layer may include sol-gel mixed with oxide nanoparticles. In some embodiments, the oxide nanoparticles may be selected from a group consisting of: aluminum oxide nanoparticles, silicon oxide nanoparticles, titanium oxide nanoparticles, indium oxide nanoparticles and aluminum doped zinc oxide nanoparticles

In some embodiments, the first protective layer may have a refractive index of less than 1.6. In some embodiments, the first protective layer may have a transmittance of at least 93% in the solar spectrum. In some embodiments, the absorbing layer may include black pigment particles embedded in a porous silica binder. In some embodiments, the coating may include a second protective layer coated on top of the first protective layer. In some embodiments, the second protective layer may include sol-gel that penetrates open porosity left after the application of the first protective layer.

A solar tube according to some embodiments of the invention may include a tube (e.g., a metallic tube, ceramic tube, and the like) coated with a coating according to embodiments disclosed herein.

Some additional aspects of the invention may be related to a method of coating solar tubes for a central tower receiver. In some embodiments, the method may include applying a porous absorbing layer on an outer surface of a tube (e.g., metallic or ceramic), the absorbing layer comprises an absorbing black pigment material mixed with a porous binder having open porosity; and applying a first protective layer on top of the porous absorbing layer. In some embodiments, the first protective layer may include oxides. In some embodiments, during the application the first protective layer penetrates through at least a portion of the open porosity.

In some embodiments, the method may include applying a second protective layer on top of the first protective layer. In some embodiments, the first protective layer may have a thickness of at most 500 nm. In some embodiments, the first protective layer may include sol-gel mixed with oxide nanoparticles. In some embodiments, the oxide nanoparticles are selected from a group consisting of: aluminum oxide nanoparticles, silicon oxide nanoparticles, titanium oxide nanoparticles, indium oxide nanoparticles and aluminum doped zinc oxide nanoparticles.

In some embodiments, the method may include curing the first protective layer and/or the second protective layer.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an illustration of a cross section of a metal tube coated according to some embodiments of the invention;

FIG. 2 is a schematic drawing of a microstructure of a coating according to some embodiments of the invention;

FIG. 3 is a flowchart of a method of coating metal tubes according to some embodiments of the invention; and

FIG. 4 is a graphical representation of absorptance behavior of commercially coated samples in comparison to samples coated according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Some aspect of the invention may be directed to the protection of a black solar paint on a central tower receiver. The protection may be achieved by applying a transparent protective layer on top of the black solar paint. The transparent protective layer may provide mechanical and optical stability to the black paint at temperatures as high as 750° C. The protective layer may include various oxide nanoparticles in an oxide containing matrix. Applying the additional protective layer to the black paint may decrease the degradation process of the paint at high temperature, high radiation flux and harsh environmental contaminations, such as high humidity levels, high air pollution levels and sand storms.

In some embodiments, the protective layer may be a transparent silicon oxide layer that doesn't affect the initial optical properties, such as absorptance and emissivity, of the black paint.

In some embodiments, the black paint may have a rough and porous surface structure. In some embodiments, a silica gel may have the capability of penetrating through the cavities and open porosity of the black paint. Applying a protective layer based on silica-gel (e.g., SiO₂ based sol-gel) followed by drying and curing of the protective layer at a high temperature may result in the formation of chemical bonding between the silica gel and the black spinel pigments. In some embodiments, such a protective layer may restrain the oxidation and degradation of the black spinel particles and the binder in the black paint, thus stabilizing the black paint layer.

In some embodiments, rheological properties, length of the silica-gel polymer chains and the crystallization degree of the polymer after curing may all be important factors that may affect the capability of the silica gel to penetrate and encapsulate the black spinel particles to enhance stabilization. For example, a silica gel may be obtained by the hydrolyzation of Tetra Ethyl Ortho Silicate (TEOS) with a nitric acid in ethanol.

In some embodiments, anti-reflective, anti-scratch nanoparticles may be inserted into the transparent silica gel. Nanoparticles such as SiO₂ or Al₂O₃ may improve the absorbance of the coating and its abrasion resistance.

In some embodiments, the protective layer may consist of at least two layers of coating: a first layer which may include a first coating material to be applied directly to the external surface of the paint. The first coating material may include a silica gel with penetration capability and nanoparticles, to fill the large voids in the paint. In some embodiments, some or all of the first layer may be soaked or embedded in the porous paint, as to fill the voids in the paint. The second layer may include a second coating material, deposited on top of the first layer. The second coating material may include solely sol-gel (e.g., silica gel) to fill the smaller voids left after filling with the first material.

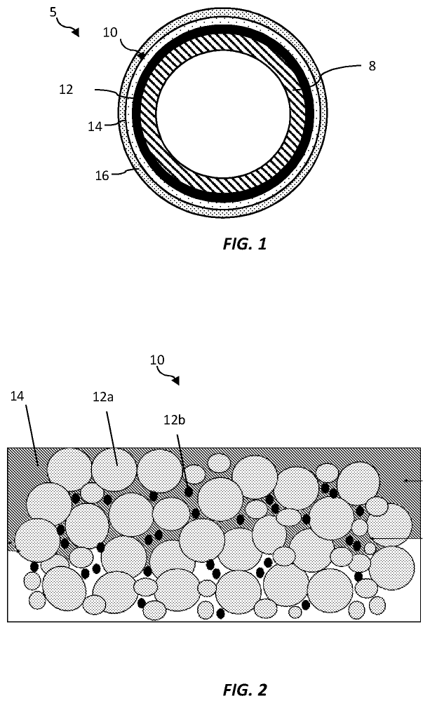

Reference is made to FIG. 1 which is an illustration of a cross section of a tube in a central tower receiver in solar power plants according to some embodiments of the invention. Coated tube 5 may include a tube 8 and a coating 10. Coating 10 may include an absorbing layer 12 and a first protective layer 14 deposited on top of absorbing layer 12. In some embodiments, coating 10 may further include a second protective layer 16 deposited on top of layer 14. Tube 8 may include any suitable metal or alloy, for example, Inconel 625, stainless steel, Hayne 230, etc. Tube 8 may include any suitable ceramic material.

Absorbing layer 12 may include any suitable absorbing black paint material, for example, a material that includes a black pigment. The black pigment may include for example, cobalt oxide, black spinel oxides such as, FeMnCuOₓ spinel (copper manganese ferrite) and copper chrome oxide and the like. The black pigment may be mixed with various binders to form the black paint and may be applied to the outer surface of tube 8 using any known method. For example, the black pigment may be mixed with a silicone binder, mixed with phenylmethyl-polysiloxane binder or with any other binder, for example, phenyl siloxane, methyl siloxane, polysilazane and the like. The black pigment-binder mixture may be painted, sprayed, dip coated and the like on the outer surface of tube 8.

In some embodiments, the thickness of the absorbing layer 12 may vary between 3 to 50 microns, for example, between of 5 to 20 microns and between 5-10 microns.

Protective layer 14 deposited on top of absorbing layer 12 may include sol-gel (e.g., silica gel) or any other solution comprising oxides. In some embodiments, the sol-gel may be mixed with oxides nanoparticles (e.g., having particle size of less than 300 nm, for example, 100-300 nm). In some embodiments, the oxide nanoparticles may include at least one of: antireflective nanoparticles (e.g. silicon oxide nanoparticles (100-300 nm) and/or aluminum oxide nanoparticles (4-5 nm) mixed with silica sol-gel. In some embodiments, the oxide nanoparticles may include at least one of aluminum oxide nanoparticles, silicon oxide nanoparticles, titanium oxide nanoparticles, indium oxide nanoparticles, aluminum doped zinc oxide nanoparticles and the like. The oxide nanoparticles may be dispersed in any binder or solution to be applied, for example, by airbrushing, spraying, painting, dipping, printing and the like on top of absorbing layer 12. In some embodiments, protective layer 14 may be cured and may include after curing oxides nanoparticles embedded in an oxides matrix.

In some embodiments, protective layer 14, after curing, may have a thickness of at most 500 nm, for example, at most 200 nm, at most 150 nm, 100 nm or less. In some embodiments, at least a portion of layer 14 may be absorbed, penetrated or soaked into the porous structure of layer 12, as discussed herein below. Higher thicknesses may result in harming the absorbing properties of the absorbing layer 12. In some embodiments, the thickness of protective layer 14 may be at least 25 nm. The ability of coating 10 to both absorb the desired amount of radiation and/or protect the absorbing layer from mechanical damage is due to the special microstructure of coating 10. A layer 14 according to some embodiments of the invention may have low refractive index of less than 1.6 (e.g., less than 1.5, 1.42 or less). In some embodiments, layer 14 may have transmittance of at least 93%, for example, 94%, 95%, 96% and 97% in the solar spectrum (e.g., wavelength of 300 nm to 2500 nm).

In some embodiments, coating 10 microstructure may include a porous absorbing layer 12 that includes for example, black spinel nanoparticles embedded in a porous silicon oxide binder (matrix) covered by layer 14. In some embodiments, layer 14 may penetrate and fill at least some of the voids of porous layer 12, as illustrated and discussed below with respect to FIG. 2.

FIG. 2 is an illustration of the microstructure of coating 10 according to some embodiments of the invention. Coating 10 may include porous absorbing layer 12 that may include black pigment particles 12b embedded in porous binder (matrix) 12a. Black pigment particles 12b may include, for example, cobalt oxide, black spinel oxides such as, FeMnCuOₓ spinel (copper manganese ferrite) and copper chrome oxide and the like. Porous matrix 12a may include a silicone binder, mixed with phenylmethyl-polysiloxane binder or with any other binder, for example, phenyl siloxane, methyl siloxane, polysilazane and the like.

In some embodiments, protective layer 14 may penetrate to at least a portion of the open porosity in layer 12 and at least partially encapsulate layer 12. Layer 14 may include a sol-gel (e.g., a silica gel) that may or may not be mixed with oxide nanoparticles. Accordingly, the microstructure of coating 10 may include a composite made from at least three different materials, black pigment particles 12b, a matrix 12a (which is the binder of absorbing layer 12 binding black pigment particles 12b) and sol-gel. In some embodiments, when oxide nanoparticles are added to the sol-gel coating 10 include a composite material made from four different materials. In some embodiments, a sol-gel with oxide nanoparticles may improve the penetration of layer 14 into the voids of layer 12. In some embodiments, after curing the sol-gel matrix may become an oxide matrix.

Refereeing back to FIG. 1, in which second protective layer 16 may be applied on top of first protective layer 14. In some embodiments, layer 16 may include only sol-gel (e.g., silica gel) and may be applied to further penetrate and fill residual voids (open porosity) in layers 12 and 14 left after the application of first protective layer 14. After curing second protective layer 16 may include an oxide matrix.

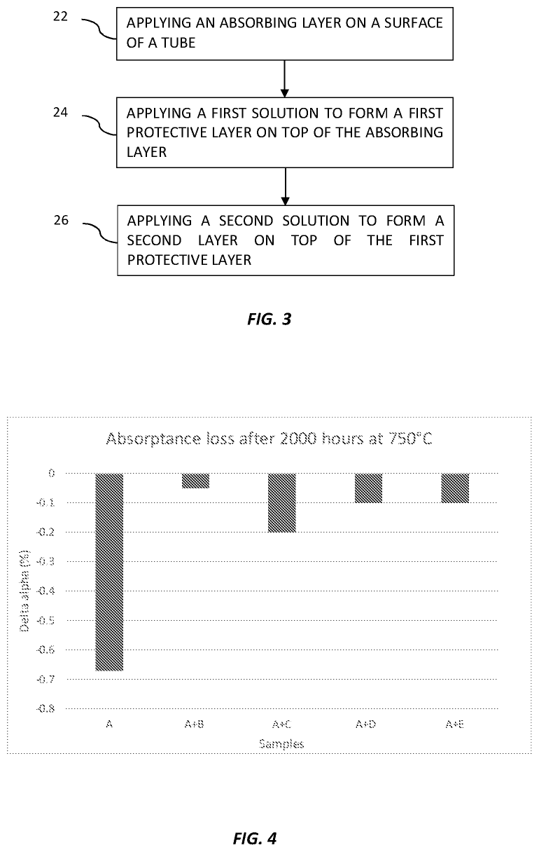

Reference is now made to FIG. 3 which is a flowchart of a method of coating tubes of a central tower receiver in solar power plants according to some embodiments of the invention. In box 22, a porous absorbing layer (e.g., absorbing layer 12) may be applied to a surface (e.g., outer surface) of a tube (e.g., tube 8) using any application method known in the art, for example, airbrushing, spraying, painting, dipping, printing or the like. In some embodiments, cleaning and/or other surface preparation processes may be performed prior to the application of the absorbing layer. In some embodiments, surface preparation may be essential to assure a good adhesion of the absorbing layer on the tube. In some embodiments, layer 12 may further be dried and optionally cured. An example of applying an absorbing layer (layer A) is given below.

In box 24, a first solution to form a first protective layer (e.g., layer 14) may be applied on top of the absorbing layer (e.g., layer 12) and penetrates through at least a portion of the porous structure of the absorbing layer, as disclosed above with respect to FIG. 2. The first solution may include sol-gel (e.g., silica gel) with or without an addition of oxide nanoparticles as disclosed above.

A first solution that includes the sol-gel (with or without an addition of oxide nanoparticles) may be airbrushed, sprayed, painted, dipped, printed or the like on top of layer 12. Examples for applying protective layers B and C, on top of the black spinel oxide-silicone layer A discussed above, are given below.

In box 26, a second solution for forming a second protective layer (e.g. layer 16) may be applied on top of the first protective layer. In some embodiments, the second protective may at least partially penetrate via small voids left after applying the first protective layer. In some embodiments, no curing is required between the application of the first and second protective layers. A second solution that includes sol-gel may be airbrushed, sprayed, painted, dipped, printed or the like on top of the first protective layer. An example for applying two consecutive protective layers (B+C) is given in layer D below.

In some embodiments, the method may further include curing layers 12, 14 and/or 16 using any curing method known in the art. The curing process may take place either in a separate stage(s) or together with the curing of the black paint.

### Example 1: Layer A

Inconel plates were used as the substrate, representing surfaces of Inconel tubes. The Inconel plates were washed with soap, brushed, rinsed with water and washed a second time with Isopropyl alcohol (IPA). The plates were dried and underwent a sandblast treatment. The plates were coated with a black absorbing paint, comprising manganese ferrite (a black spinel) in silicone binder, using airbrush method, to form the absorbing layer. The plates were dried for 24 hours at room temperature and then cured in an oven. The Curing profile was heating at 5° C./min for 55 minutes to 248° C., held at 248° C. for 2 hours, heating at 5° C./min for 55 minutes to 538° C. and held at 538° C. for 2 hours.

### Example 2: Layer B

Layer B included silica-gel and silicon oxide nanoparticles having a particle size of 20-40 nm to form a nano-size structure elements in the range of 100 to 200 nm after curing. A commercial colloidal solution of silica gel with silicon oxide nanoparticles was added to a solvent such that the pH of the solution was altered in order to enable a chemical reaction which enlarged the optical density of the solution. The silica-gel-silicon oxide particles solution was airbrushed on top of layer A comprising the black spinel-oxide-silicone layer, and cured using the same curing profile used for the absorbing layer A.

### Example 3: Layer C

Layer C included silicon oxide polymer chains resulting from the hydrolyzation of Tetra Ethyl Ortho Silicate (TEOS) with an acid solution. The silica-gel was airbrushed on top of layer A and cured using the same curing profile used for the absorbing layer A.

### Example 4: Layer D

Layer D was made by depositing layers B and C one on top of the other. Layer B was deposited first on top of layer A followed by the deposition of layer C. Both layers B and C were cured together using the same curing profile used for the absorbing layer A.

### Example 5: Layer E

Aluminum oxide nanoparticles (3-4 nm) were dispersed in a silica-gel resulting from the hydrolyzation of Tetra-Ethyl-Ortho-Silicate (TEOS) with an acid solution. The alumina-nanoparticles silica-gel solution was airbrushed on top of layer A and cured using the same curing profile used for the absorbing layer A.

### Experimental Results

Reference is now made to FIG. 4 which is graphical representation of absorptance measurements that were conducted on aged coated Inconel plates, coated with layers A, A+B, A+C or A+D, A+E. The measurement of the absorptance indicates the ability of the surface to absorb solar radiation. The absorptance was measured with a spectrophotometer with an integrated sphere (Varian Cary 5000). The baseline was verified prior to a daily use of the spectrophotometer. The samples were aged at elevated temperatures, 750° C. in air for 2000 hours. As can be seen, after aging at 750° C. all samples having both absorbing and protective layers (A+B, A+C and A+D, A+E) had better optical absorptance stability (delta-alpha %) than sample A coated only with absorbing layer A.

Table 1, summarizes absorptance loss, mechanical properties and corrosion resistance of coated plates A, A+B, A+C, A+D, A+E after ageing as discussed above. The coated plates were exposed to 750° C. in air for 2000 hours. Abrasion resistance, adhesion and corrosion resistance of the coatings were checked according to ASTM procedures. Adhesion was measured according to ASTM B117, corrosion resistance was measured in salt bath for 24 hours and abrasion resistance was measured according to ASTMD4060. All the plates that were coated with an additional protective layer showed better mechanical properties, less absorptance loss and better corrosion resistance compared to the plate coated solely with an absorbing layer.

TABLE 1

| | | | | Thermal resistance. |
|---|---|---|---|---|
| Coating | Abrasion | Corrosion | Adhesion | Absorptance loss after |
| types | ASTM3359 | (salt bath) | ASTM3359 | 2000 hours at 750° C. |
| A | Fail | Pass | 3-4B | 0.68% |
| A + B | Pass | Pass | 4-5B | 0.05% |
| A + C | Pass | Pass | 4-5B | 0.2% |
| A + D | Pass | Pass | 4-5B | 0.1% |
| A + E | Pass | Pass | 4-5B | 0.1% |

While certain features of the invention have been illustrated, and described herein, many modifications, substitutions, changes, and equivalents will now occur to those of ordinary skill in the art. It is, therefore, to be understood that the appended claims are intended to cover all such modifications and changes as fall within the true spirit of the invention.

1. A coating for solar tubes, comprising:
a porous absorbing layer comprising an absorbing black pigment material mixed with a porous binder having an open porosity; and
a first protective layer comprising oxides, the first protective layer is applied on top of the porous absorbing layer,
wherein the first protective layer penetrates to at least a portion of the open porosity.

2. The coating of claim 1, wherein the first protective layer has a thickness of at most 500 nm.

3. The coating of claim 1, wherein the first protective layer comprises oxide matrix with oxide nanoparticles.

4. The coating of claim 3, wherein the oxide nanoparticles are selected from a group consisting of: aluminum oxide nanoparticles, silicon oxide nanoparticles, titanium oxide nanoparticles, indium oxide nanoparticles and aluminum doped zinc oxide nanoparticles.

5. The coating according to claim 1, wherein the first protective layer has a refractive index of less than 1.6

6. The coating according to claim 1, wherein the first protective layer has transmittance of at least 93%-in the solar spectrum.

7. The coating according to claim 1, wherein the absorbing layer includes black pigment particles embedded in a porous silica binder.

8. The coating according to claim 1, further comprising a second protective layer coated on top of the first protective layer.

9. The coating of claim 8, wherein the second protective layer is applied by using sol-gel that penetrates to open porosity left after the application of the first protective layer.

10. A solar tube comprising:
a tube; and
a coating according to claim 1, coated on an outer surface of the tube.

11. A method of coating solar tubes for a central tower receiver, comprising:
applying a porous absorbing layer on an outer surface of a tube, the absorbing layer comprises an absorbing black pigment material mixed with a porous binder having open porosity; and
applying a first solution to form a first protective layer on top of the porous absorbing layer,
wherein the first solution layer comprises oxides, and
wherein during the application of the first solution, the first solution penetrates through at least a portion of the open porosity.

12. The method of claim 11, further comprising applying a second solution to form a second protective layer on top of the first protective layer.

13. The method of claim 11, wherein the first solution comprises sol-gel mixed with oxide nanoparticles.

14. The method of claim 13, wherein the oxide nanoparticles are selected from a group consisting of: aluminum oxide nanoparticles, silicon oxide nanoparticles, titanium oxide nanoparticles, indium oxide nanoparticles and aluminum doped zinc oxide nanoparticles.

15. The method according to claim 11, further comprising curing the first protective layer.

16. The method of claim 12, further comprising curing the second protective layer.
